(19) United States
(12) Patent Application Publication
(10) Pub. No.: US 2019/0261243 A1
(43) Pub. Date: Aug. 22, 2019

(54) VIDEO-BASED CHANNEL SELECTION IN A WIRELESS NETWORK-CONNECTED CAMERA SYSTEM

(71) Applicant: NETGEAR, INC., San Jose, CA (US)

(72) Inventors: Peiman AMINI, Mountain View, CA (US); Joseph Amalan Arul EMMANUEL, Cupertino, CA (US)

(21) Appl. No.: 16/119,242

(22) Filed: Aug. 31, 2018

Related U.S. Application Data
(60) Provisional application No. 62/633,017, filed on Feb. 20, 2018.

(51) Int. Cl. H04W 36/30; H04L 5/00; H04W 72/04; H04W 36/00; H04N 7/12

(52) U.S. Cl. CPC H04W 36/30; H04L 5/0053; H04N 7/147; H04W 36/0011; H04N 7/12; H04W 72/0453

(57) ABSTRACT

Systems and methods are introduced for video-based channel selection in wireless network connected camera systems. In an illustrative embodiment, a computing system receives data of conditions in a wireless network and data indicative of characteristics of a video stream to be transmitted over the wireless network. The computing system processes the received data to select automatically a channel from a plurality of available channels that can accommodate the transmission of the video stream. The computing system then causes a wireless link, for example between a wireless camera and the wireless access point, to be established on the selected channel or causes an existing wireless link to move from a previous channel to the selected channel

### CROSS-REFERENCE TO RELATED APPLICATION(S)

This application claims priority to U.S. Provisional Patent Application No. 62/633,017 (Attorney Docket No. 110729-8075 US00), entitled “Optimization and Testing of Wireless Devices,” by Emmanuel et al., and filed on Feb. 20, 2018. The content of the above-identified application is incorporated herein by reference in its entirety.

### TECHNICAL FIELD

The present disclosure relates to communication between devices in a wireless network, and in particular to communication involving wireless video cameras in a network-connected video camera system.

### BACKGROUND

A video surveillance system can provide security, for example, in a home environment. Some video surveillance systems may include wireless video cameras configured to capture video of a surrounding environment, encode the captured video into a video stream, and wirelessly transmit the encoded video stream to a viewing device, for example, over a wireless local area network (WLAN).

### BRIEF DESCRIPTION OF THE DRAWINGS

The present embodiments are illustrated by way of example and are not intended to be limited by the figures of the accompanying drawings.

FIG. 1 is a block diagram of an example environment in which the introduced technique for video-based channel selection can be implemented;

FIG. 2 is a block diagram of an example wireless networking device;

FIG. 3 is a block diagram showing an example multi-band wireless network including multiple wireless networking devices providing coverage to wireless cameras;

FIG. 4 is a block diagram of an example module for implementing the introduced technique for video-based channel selection;

FIG. 5 is a flow chart of an example process for video-based channel selection;

FIG. 6 is a diagram that illustrates different scenes captured by different cameras in a network-connected camera system;

FIG. 7 is a flow chart of an example process for switching channels based on the described technique for video-based channel selection;

FIG. 8 is a flow chart of an example process for switching channels that avoids switching during an active video stream;

FIG. 9 is a flow chart of an example process for immediately switching channels in response to detecting a critical failure;

FIG. 10 is a flow chart of an example process for channel switching with channel switch announcement;

FIG. 11 is a diagram of channel allocation in the 5 GHz frequency band;

FIG. 12 is a flow chart of an example process for operating on a dynamic frequency selection (DFS) channel;

FIG. 13 is a flow chart of an example process for responding to strong interference that close to a wireless access point;

FIG. 14 is a flow chart of an example process for responding to strong interference that close to a wireless camera; and

FIG. 15 is block diagram of an example computer system as may be used to implement features of some embodiments of the disclosed technology.

### DETAILED DESCRIPTION

### Overview

Wireless video cameras in a network-connected camera system have many advantages, including lowered installation costs and greater installation flexibility, but can be prone to interference from other signals in increasingly congested wireless communications environments. Interference can degrade wireless communication performance which, in the context of camera systems, can significantly lower video quality.

Introduced herein is a technique for video-based channel selection that addresses these challenges. In an illustrative embodiment, a computing system (e.g., at a wireless access point) receives data of conditions in a wireless network and data indicative of characteristics of a video stream to be transmitted over the wireless network. The computing system processes the received data to select automatically a channel from a plurality of available channels that can accommodate the transmission of the video stream. The computing system then causes a wireless link, for example between a wireless camera and the wireless access point, to be established on the selected channel or causes an existing wireless link to move from a previous channel to the selected channel.

In some embodiments, the computing system may perform video-based channel selection periodically, for example, once per day and may avoid switching channels during active video streams unless critical failures are detected. In embodiments involving a multi-band wireless network (e.g., operating in the 2.4 Gigahertz (GHz) and 5 GHz frequency bands), the technique for video-based channel selection may include switching between different frequency bands based on network conditions and characteristics of transmitted video streams.

By implementing smart channel planning based on knowledge of network conditions and video characteristics, the introduced technique may improve video quality in a wireless video camera system and therefore represents a significant technological improvement in the functionality of such wireless video camera systems.

### Example Operating Environment

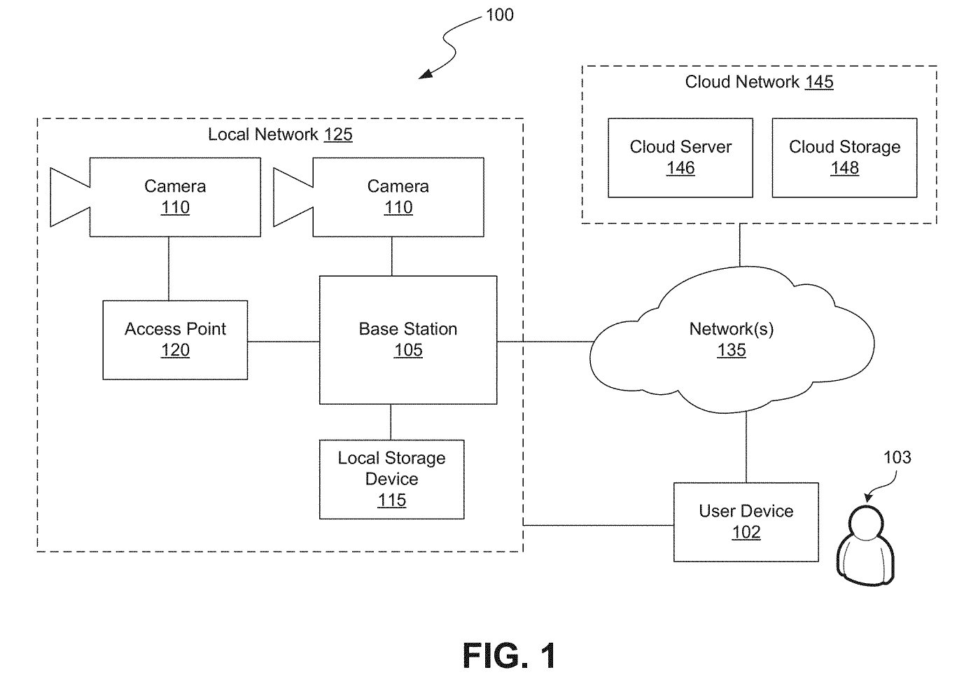

FIG. 1 is a block diagram illustrating an example environment in which the introduced technique for video-based channel selection can be implemented. The example environment 100 includes a network-connected camera system including a base station 105, one or more wireless access points (APs) 120, and one or more wireless cameras 110. In some embodiments, the camera system is a security surveillance system that can be installed in a building such as a house. The base station 105 and the camera 110 can be connected to each other via a local network 125. The local network 125 can be a local area network (LAN). In some embodiments, the local network 125 is a WLAN, such as a home Wi-Fi, created by one or more wireless accesses points (APs) 120. In some embodiments, functionality associated with base station 105 and/or wireless AP 120 are implemented in software instantiated at a wireless networking device. In other words, the system may include multiple wireless networking devices as nodes, wherein each of the wireless networking devices is operable as a wireless AP 120 and/or base station 105. The camera 110 and the base station 105 can be connected to each other wirelessly, e.g., over Wi-Fi, or using wired means. The base station 105 and the cameras 110 can be connected to each other wirelessly via the one or more wireless APs 120, or directly with each other without the wireless AP 120, e.g., using Wi-Fi direct, Wi-Fi ad hoc or similar wireless connection technologies or via wired connections. Further, the base station 105 can be connected to the local network 125 using a wired means or wirelessly.

The cameras 110 capture video, encode the video as a video stream, and wirelessly transmit the video stream via local network 125 for delivery to a user device 102. In some embodiments, certain cameras may include integrated encoder components. Alternatively, or in addition, the encoder component may be a separate device coupled to the wireless camera 110. For example, an analog camera 112 may be communicatively coupled to the base station 105 and/or wireless AP 120 via a wireless analog to digital encoder device. In some embodiments, the base station 105 and/or wireless APs 120 may include encoding components to encode and/or transcode video. Encoder components may include any combination of software and/or hardware configured to encode video information. Such encoders may be based on any number of different standards such as H.264, H.265, VP8, VP9, Daala, MJPEG, MPEG4, WMV, etc. for encoding video information. Accordingly, depending on the codec used, the video stream from a given camera 110 may be one of several different formats such as .AVI, .MP4, MOV, .WMA, .MKV, etc. The video stream can include audio as well if the camera 110 includes or is communicatively coupled to an audio device (e.g., a microphone).

The cameras 110 can be battery powered or powered from a wall outlet. In some embodiments, the cameras 110 can include one or more sensors such as motion sensors that can activate the capture of video, encoding of captured video, and/or transmission of an encoded video stream when motion is detected. The cameras 110 can include infrared (IR) light emitting diode (LED) sensors, which can provide night-vision capabilities. Although the example environment 100 illustrates two cameras 110, the camera system can include just one camera or more than two cameras, which can be installed at various locations of a building. In some embodiments all the cameras in the camera system can have same features, or at least some of the cameras can have different features. For example, one camera can have a night-vision feature while another may not. One camera can be battery powered while another may be powered from the wall outlet.

The base station 105 can be a computer system that serves as a gateway to securely connect the cameras 110 to an external network 135, for example, via one or more wireless APs 120. The external network 135 may comprise one or more networks of any type including packet switched communications networks, such as the Internet, Worldwide Web portion of the Internet, extranets, intranets, and/or various other types of telecommunications networks such as cellular phone and data networks, plain old telephone system (POTS) networks, etc.

The base station 105 can provide various features such as long range wireless connectivity to the cameras 110, a local storage device 115, a siren, connectivity to network attached storage (NAS) and enhance battery life of cameras 110, e.g., by making the cameras 110 work efficiently and keeping the communications between the base station 105 and the cameras 110 efficient. The base station 105 can be configured to store the video captured from the cameras 110 in any of the local storage device 115, a NAS, or a cloud storage 148. The base station 105 can be configured to generate a sound alarm from the siren when an intrusion is detected by the base station 105 based on the video streams receive from cameras 110/112.

Another feature of the base station 105 is that it can create its own network within the local network 125, so that the cameras 110 may not overload or consume the network bandwidth of the local network 125. The cameras 110 typically connect to the base station 105 wirelessly. In some embodiments, the local network 125 can include multiple base stations to increase wireless coverage of the base station 105, which may be beneficial or required in cases where the cameras are spread over a large area.

In some embodiments the local network 125 can provide wireless coverage to user devices (e.g., user device 102), for example, via wireless APs 120. In the example environment 100 depicted in FIG. 1, a user device 102 can connect to the base station 105, for example, via the local network 125 if located close to the base station 105 and/or wireless AP 120. Alternatively, the user device 102 can connect to the base station 105 via network 135 (e.g., the Internet). The user device 102 can be any computing device that can connect to a network and play video content, such as a smartphone, a laptop, a desktop, a tablet personal computer (PC), or a smart TV.

In an example embodiment, when a user 103 sends a request (e.g., from user device 102), to view a live video feed from any of cameras 110, the base station 105 receives the request and in response to receiving the request, obtains the encoded video stream(s) from one of the cameras 110 and transmits the encoded video stream to the user device 102 for viewing. Upon receiving the encoded video stream at the user device 102, a video player application in the user device 102 decodes the encoded video stream and plays the video on a display on the user device 102 for the user 103 to view.

As previously mentioned, in some embodiments, the base station 105 may include an encoding/transcoding component that performs a coding process on video received from the cameras before streaming to the user device 102. In an example embodiment, a transcoder at the base station 105 transcodes a video stream received from a camera 110, for example, by decoding the encoded stream and re-encoding the stream into another format to generate a transcoded video stream that is then streams to the user device 102.

The video stream received at the user device 102 may be a real-time video stream and/or a recorded video stream. For example, in some embodiments, the transcoder 106 may transcode an encoded video stream received from a camera 110 and stream the transcoded video stream to the user device 102 in real-time or near real-time (i.e., within several seconds) as the video is captured at the camera 110. Alternatively, or in addition, the video streamed by base station 105 to the user device may be retrieved from storage such as local storage 115, cloud storage 148, or some other NAS.

The base station 105 can stream video to the user device 102 in multiple ways. For example, the base station 105 can stream video to the user device 102 using peer-to-peer (P2P) streaming technique. In P2P streaming, when the video player on the user device 102 requests the video stream, the base station 105 and the user device 102 may exchange signaling information, for example via network 135 or a cloud network 145, to determine location information of the base station 105 and the user device 102, to find a best path and establish a P2P connection to route the video stream from the base station 105 to the user device 102. After establishing the connection, the base station 105 streams video to the user device 1.02, eliminating the additional bandwidth cost to deliver the video stream from the base station 105 to a video streaming server 146 in a cloud network 145 and for streaming from the video streaming server 146 to the user device 102. In some embodiments, a server 146 in the cloud network may keep a log of available peer node servers to route the video stream and establish the connection between the user device 102 and other peers. In such embodiments, instead of streaming video, the server 146 may function as a signaling server or can include signaling software whose function is to maintain and manage a list of peers and handle the signaling between the base station 105 and the user device 102. In some embodiments, the server 146 can dynamically select the best peers based on geography and network topology.

In some embodiments, the cloud network 145 is a network of resources from a centralized third-party provider using Wide Area Networking (WAN) or Internet-based access technologies. Cloud networking is related to the concept of cloud computing, in which the network or computing resources are shared across various customers or clients. The cloud network 145 is distinct, independent, and different from that of the local network 125.

In some embodiments, the local network 125 is implemented as multi-band wireless network comprising one or more wireless networking devices (also referred to herein as nodes) that function as wireless APs 120 and/or a base station 105. For example, with respect to the example environment 100 depicted in FIG. 1, bases station 105 may be implemented at a first wireless networking device that functions as a gateway and/or router. That first wireless networking device may also function as a wireless AP. Other wireless networking devices may function as satellite wireless APs that are wirelessly connected to each other via a backhaul link. The multiple wireless networking devices provide wireless network connections (e.g., using Wi-Fi) to one or more wireless client devices such as cameras 110 or any other devices such as desktop computers, laptop computers, tablet computers, mobile phones, wearable smart devices, game consoles, smart home devices, etc. The wireless networking devices together provide a single wireless network (e.g., network 125) configured to provide broad coverage to the client devices. The system of wireless networking devices can dynamically optimize the wireless connections of the client devices without the need of reconnecting. An example of the multi-band wireless networking system is the NETGEAR® Orbi® system. Such systems are exemplified in U.S. patent application No. 15/287,711, filed Oct. 6, 2016 and Ser. No. 15/271,912, filed Sep. 21, 2016, now issued as U.S. Pat. No. 9,967,884 both of which are hereby incorporated by reference in their entireties for all purposes.

The wireless networking devices of a multi-band wireless networking system can include radio components for multiple wireless bands, such as 2.5 GHz frequency band, low 5 GHz frequency band, and high 5 GHz frequency band. In some embodiments, at least one of the bands can be dedicated to the wireless communications among the wireless networking devices of the system. Such wireless communications among the wireless networking devices of the system is referred to herein as “backhaul” communications. Any other bands can be used for wireless communications between the wireless networking devices of the system and client devices such as cameras 110 connecting to the system. The wireless communications between the wireless networking devices of the system and client devices are referred to as “fronthaul” communications.

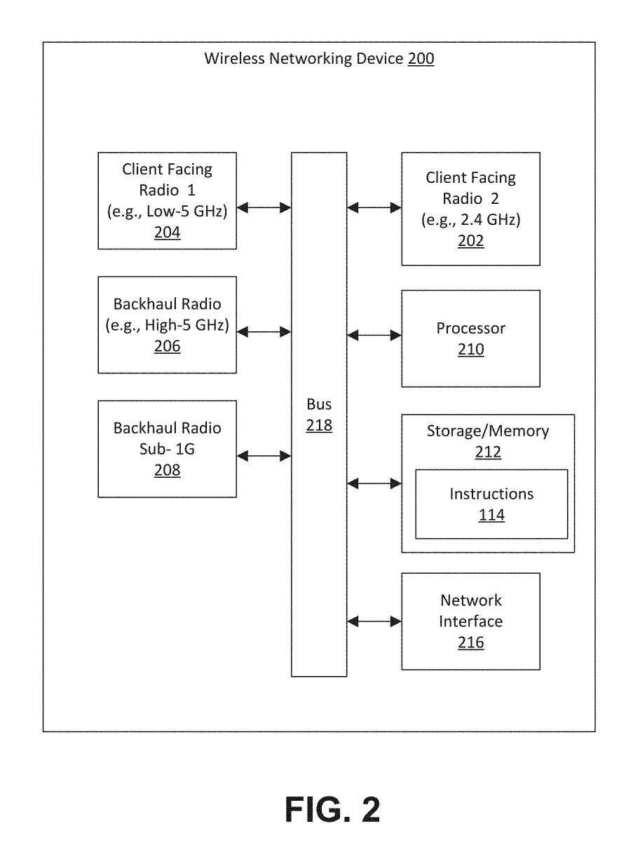

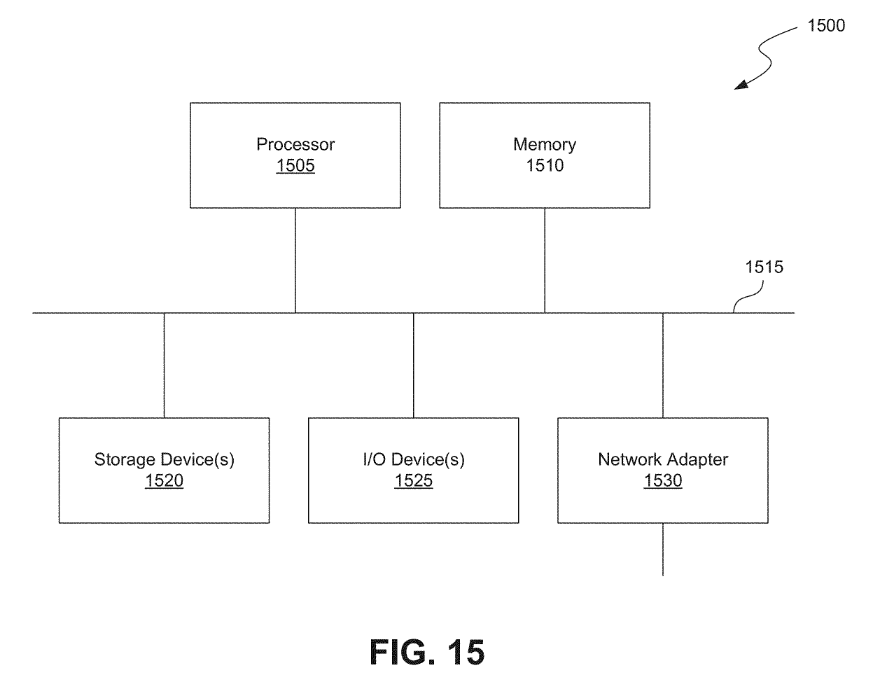

FIG. 2 is a block diagram of an example wireless networking device 200 that may implement functionality of a base station 105 and/or wireless AP 120, for example, to establish a multi-band wireless network (e.g., local network 125). In sonic embodiments, the example wireless networking device 200 includes radio components for communication over multiple wireless bands, such as 2.4 GHz band radio 202, a 5 GHz low band radio 204, 5 GHz high band radio 206, and a sub-1 GHz radio 208. The wireless networking device 200 also includes a processor 210 for executing program logic, a digital storage or memory 212 including instructions 214 to be executed by the processor 210. The wireless networking device 200 may also include a network interface 216 for connecting to a wired network and providing overall access to the Internet to the system, though generally only a base unit (i.e., gateway or router) includes a wired connection to the Internet. The various components of the example wireless networking device 200 are communicatively coupled via a bus 218. The wireless networking device 200 depicted in FIG. 2 is an example provided for illustrative purposes. Other wireless networking devices may include fewer or more components than as shown in FIG. 2. Additional details regarding some of the components of the example wireless networking device 200 may be described with the respect to the example computing system 1500 in FIG. 15.

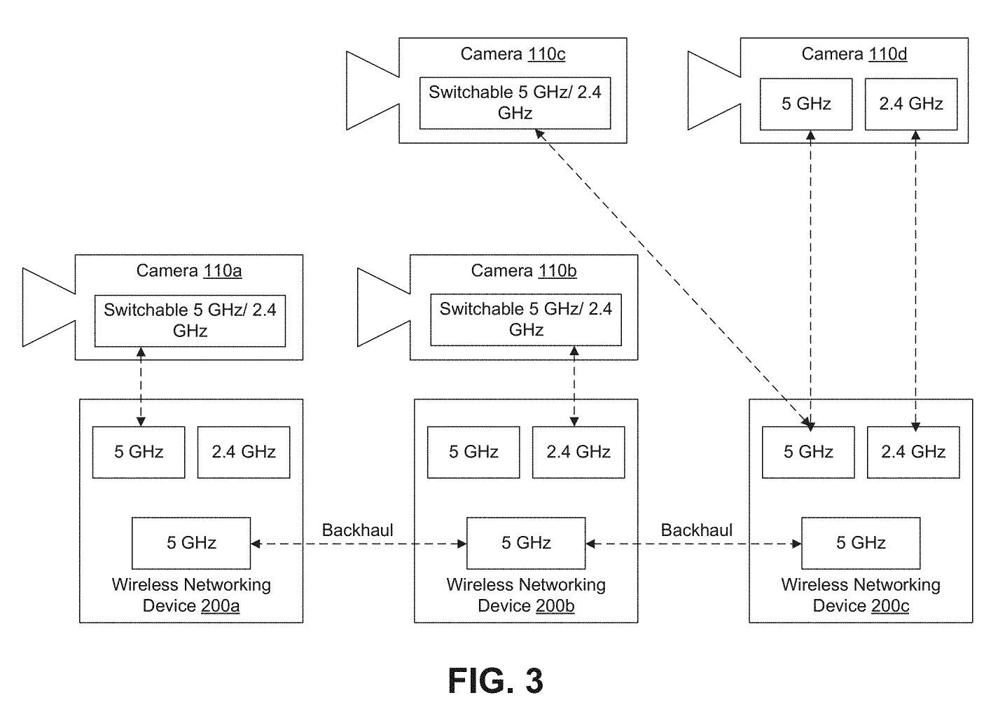

FIG. 3 is a block diagram showing an example multi-band wireless network involving multiple wireless networking devices 200a-c providing coverage to clients such as a wireless cameras 110a-d. The wireless networking devices 200a-c depicted in FIG. 3 may be the same or similar to example wireless networking device 200 depicted in FIG. 2. The multiple wireless networking devices 200a-c may be implemented as mesh points collectively comprising a mesh network, other network topology configurations such as ring, star, etc. can similarly be implemented. Similar to example wireless networking device 200, each of the multiple wireless networking devices 200a-c may include multiple radios operable in different bands to facilitate fronthaul communications with clients (e.g., cameras 110a-d) and backhaul communications with each other. For example, each of the multiple wireless networking devices 200a-c include a radio (e.g., a 5 GHz high band radio) dedicated for backhaul communications between wireless networking devices as well as multiple client facing radios (e.g., a 5 GHz low band radio and 2.4 GHz radio) for communication with client devices such a cameras 110a-d. In some embodiments, at least one radio at each wireless networking device 200a-c is used to establish a dedicated backhaul between the devices. Those skilled in the art will appreciate that the number of wireless networking devices and radios per wireless networking device can vary depending on the implementation. For example, although not shown in FIG. 3, the wireless networking devices 200a-c may also include sub-1 GHz radios (e.g., as shown in FIG. 2) that may be used to establish an additional dedicated backhaul between nodes, for example, for control communications.

Client devices such as cameras 110a-d can connect to wireless networking devices 200a-c (e.g., operable as wireless APs) over one or more channels in one or more bands, for example, to transmit video streams. Some wireless cameras (e.g., cameras 110a-c) may include switchable radios configured to switch between available bands (e.g., 2.4 GHz and 5 GHz) of the multi-band wireless network. In sonic embodiments, certain wireless cameras (e.g., camera 110d) may include multiple radios configured for communication in each of the bands. In some embodiments, certain client with multiple radios (e.g., camera 110d) may be configured to simultaneously communicate over multiple bands (e.g., 2.4 GHz and 5 GHz). In some embodiments, any two wireless APs in the multi-band wireless network may service clients using a different channel in a different band. For example, a first wireless AP implemented by wireless networking device 200a may provide coverage to clients (e.g., camera 110a) via a particular channel in the 5 GHz frequency band while a second wireless AP implemented by wireless networking device 200b provides coverage to clients (e.g., camera 110b) via another channel in the 2.4 GHz frequency band. Similarly, any two wireless APs may provide coverage via different channels within the same band (e.g., two different channels in the 5 GHz frequency band).

As will be described in more detail, the decision on which channel (and in which band) to utilize will depend on a number of different factors including conditions of the networked environment, capabilities of the clients, and characteristics of the traffic (e.g., video streams) communicated over the network. Channel selection can be performed during system boot up, during periodic channel optimization, and/or based on detected events (e.g., detected interference, new clients connecting, latency spikes, etc.). Decisions on channel selection can be made in a centralized or distributed way by any computing system operating as part of network-connected cameras system.

In an example distributed way, each node (e.g., each wireless AP) makes a decision on channel selection for itself based on available information. For example, in some embodiments, each wireless AP comprising the network individually selects a fronthaul channel for communication with clients (e.g., wireless cameras 110) based on information available to the wireless AP. Alternatively, in some embodiments, the multiple wireless APs may coordinate with each other to optimize channel selection across the network. For example, the multiple wireless APs may transmit data indicative of network conditions at multiple locations to each other to utilize for channel selection and communicate channel selections to each other to avoid interference.

In a centralized way, a central node (e.g., a base station) makes decisions of channel selections for all other satellite nodes (e.g., other wireless APs) of the system. This may be communicated through control communications over a backhaul link. Each satellite node may establish backhaul link with the central node or an intermediate satellite node and scan the channels in the fronthaul band(s). Each satellite node may then send detailed information regarding candidates of fronthaul channels to the central node through control communications via the backhaul link. The detailed information can include, for example, scan results on all channels in the fronthaul band(s) and conditions on all channels in the fronthaul band(s). The central node then makes a centralized decision on channel selection for each of the satellite nodes.

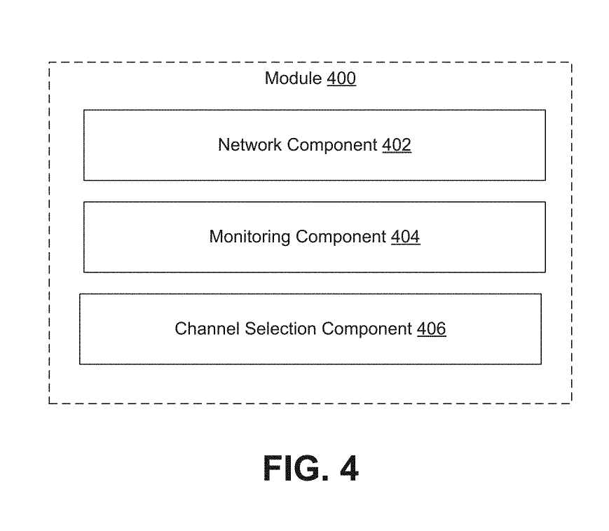

FIG. 4 is a block diagram of an example module 400 for implementing the introduced technique for video-based channel selection. The example module 400 may include multiple functional components including a network component 402, a monitoring component 404, and a channel selection component 406. The network component 402 establishes the connection with a local network (e.g., local network 125), and between the base station 105 and/or wireless APs 120 and the one or more cameras 110. The monitoring component 404 monitors for inputs, for example data indicative of conditions in the wireless network and/or characteristics of a video stream to be transmitted over the wireless network. The monitoring component may operate passively to receive data from other entities and/or actively, for example, to perform measurements of various network conditions such as interference, channel utilization, etc. The monitoring component 404 may also operate to perform scanning of the carious available channels to facilitate the channel selection process. The channel selection component 406 receives the inputs gathered by the monitoring component 404 and selects channels in one or more frequency bands for fronthaul communications with clients such as wireless cameras 110. In some embodiments, the channel selection component 406 may include functionality to announce channel selection client such as wireless cameras 110

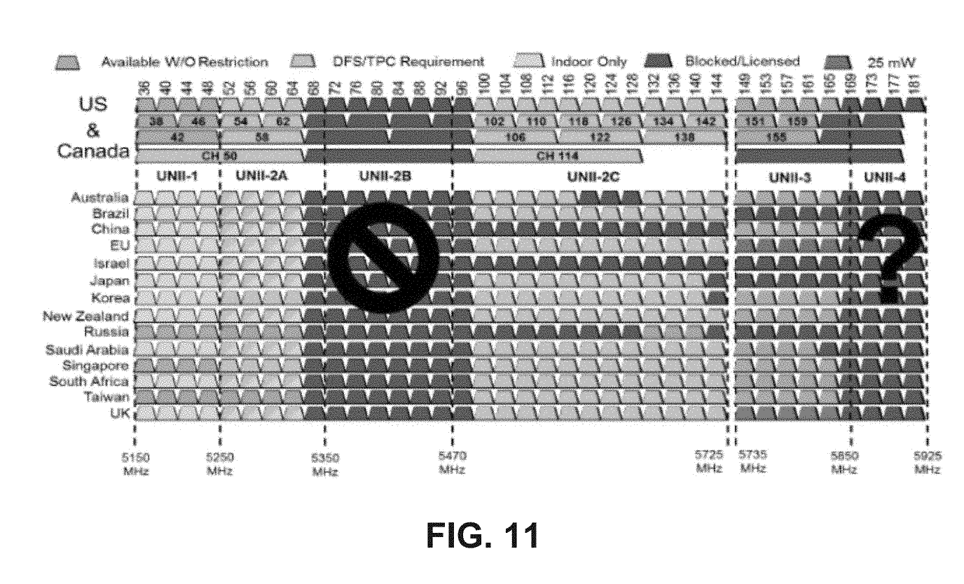

The module 400 depicted in FIG. 4 is an example provided for illustrative purposes and is not to be construed as limiting. Other embodiments may include more or fewer components than as depicted in FIG. 4 and/or may group components differently. For example, in some embodiments, monitoring and channel selection may be configured as a single logical component instead of separate components of the module. Functionality associated with the various components of example module 400 may be implemented using one or more computing systems such as the example computing system 1500 described with respect to FIG. 15. For example, functionality may be implemented using instructions stored in memory that are then executed by a processor of a computing system. In some embodiments, the functionality associated with the various components of example module 400 may be implemented using any combination of software and/or hardware at any of the entities (e.g., devices, services, etc.) described with respect to the example environment 100 shown in FIG. 11. For example, in some embodiments, module 400 may be implemented in hardware and/or software at the base station 105 and/or at wireless APs 120. Alternatively, functionality associated with different components of module 400 may be distributed across the various entities described with respect to the example environment 100 shown in FIG. 1. For example, wireless cameras 110 may include a monitoring component to perform measurements of network conditions while the channel selection component resides at a wireless AP 120.

### Video-Base Channel Selection in a Multi-Band Wireless Network

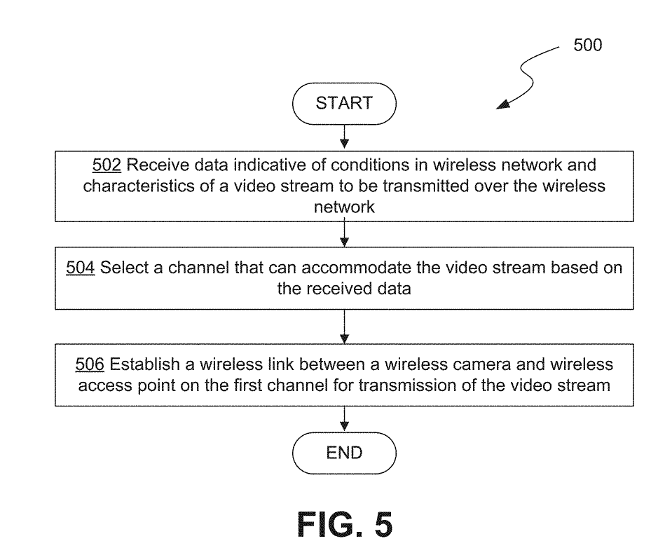

FIG. 5 shows a flow chart of an example process 500 for video-based channel selection in a multi-band wireless network. For illustrative clarity, the example process is described as being performed by a computing system (e.g., such as computing system 1500 described with respect to FIG. 15). For example, the process depicted in FIG. 5 may be represented in instructions stored in memory that are then executed by a processor. A person having ordinary skill in the art will understand that the components of such a computing system may be distributed across one or more entities of the example environment 100 described with respect to FIG. 1. The process 500 described with respect to FIG. 5 is an example provided for illustrative purposes and is not to be construed as limiting. Other processes may include more or fewer steps than depicted while remaining within the scope of the present disclosure. Further, the steps depicted in example process 500 may be performed in a different order than is shown.

The example process 500 begins at step 502 with receiving data indicative of conditions in a wireless network and of a video stream to be transmitted over the wireless network. For example, in the context of example environment 100, step 502 includes receiving data indicative of conditions in the local network 125 (e.g., a multi-band wireless network) and data indicative of characteristics of a video stream that will be wirelessly transmitted by one or more of the cameras 110 over the local network 125.

Data indicative of network conditions can include for example, measures of any of interference, channel utilization, bandwidth, throughput, noise, packet loss, latency, signal range, signal strength, or any other metrics associated with the wireless network. Data indicative of network conditions may also include information regarding devices operating on the network. For example, data indicative of network conditions may include a count of a number of wireless APs 120 in the network detected by a given device such as another wireless AP 120 or a client such as a wireless camera 110. Data indicative of network conditions may also information associated with other detected devices. For example, a first wireless AP 120 may detect, based on received signals, the presence of one or more other wireless APs 120 (or other devices) in proximity to the first wireless AP and may determine, based on received signals, locations of the other wireless APs 120 and channels/bands that the other wireless APs are operating on.

In some embodiments, step 502 may include performing measurements to gather data indicative of network conditions. For example, step 502 may include causing any of a wireless camera 110, base station 105, or wireless AP 120 to perform measurements to determine, for example, any of interference, channel utilization, bandwidth, throughput, noise, packet loss, latency, signal range, signal strength, etc. from the perspective of the measuring device. Network standard IEEE 802.11k, which generally enables connections to the best available access point in a wireless network, defines certain measurements (e.g., for channel utilization) which can be utilized to gather data when performing the described technique for video-based channel selection. Other standard-defined and non-standard measurements can similarly be utilized to gather data indicative of network conditions.

Measurements can be performed continuously, continually (e.g., periodically according to some set schedule), or in response to certain events (e.g., requests by new devices connecting to the network). In some embodiments, measurements are performed continually over a set period of time (e.g., several days) and aggregated at the end of the period of time to before being input as data into the channel selection process. For example, a wireless AP 120 may monitor interference over one day and then generate aggregated measurements such as average interference, maximum interference, minimum interference, etc. for the day. These aggregated measurements may then be input as data indicative of network conditions at step 502 of example process 500.

In some situations, performing measurements can introduce traffic to the network (e.g., in the form of beacons) that can impact other traffic. To avoid impacting video streams from wireless cameras, such measurements can be coordinated to avoid being performed when critical video is being transmitted. For example, in a video surveillance context involving motion triggered wireless cameras, the wireless cameras may actually remain in sleep mode a majority of time and only wake to capture and transmit video in response to detecting motion. The system can therefore be configured such that various entities (e.g., wireless cameras 110, base station 105, wireless AP 120) only perform measurements when video (or at least certain critical video) is not being transmitted over the network.

In some embodiments, step 502 can include scanning (e.g., by a wireless AP 120) one or more of a plurality of available channels in one or more available frequency bands to identify one or more candidate channels that may be available for selection. Candidate channels may include channels that satisfy one or more selection criteria such as frequency band (e.g., 5 GHz vs 2.4 GHz), channel bandwidth (e.g., 20 Megahertz (MHz) vs 160 MHz), restriction requirements (e.g., non-restricted vs dynamic frequency selection (DFS) requirement), etc. As mentioned above, step 502 may include performing measurements of network conditions. Such measurements can be associated with candidate channels to facilitate the selection process. For example, a wireless AP 120 may measure interference and utilization on each of the one or more candidate channels.

Data indicative of characteristics of a video stream may include, for example, encoder parameters used to encode the video stream, a format of the video stream, power requirement for transmission of the video stream, characteristic of a scene captured in the video stream, or any other characteristic associated with a digital video stream.

Encoding of video captured by a wireless camera 110 is performed according to one or more encoder parameters. Such encoder parameters generally define the coding tools and/or algorithms that are utilized during the encoding process. Such encoder parameters may include, for example, an encoding type or standard (e.g., H.264, H.265, VP8, VP9, Daala, MJPEG, MPEG4, WMV, etc.), a selected video codec (e.g., based on any of the aforementioned types), as well as various configuration options available for the selected video codec. Configuration options for any given codec may include, for example, video output format (e.g., .AVI, .MP4, MOV, .WMA, .MKV, etc.), video output resolution, video output bitrate, frame rate, a group-of-pictures (GOP) size, speed control parameters to manage quality vs. speed during the encoding process, encoding techniques or algorithms to apply (e.g., context-based adaptive variable-length coding (CAVLC), context-based adaptive binary arithmetic coding (CABAC), etc.), rate control parameters (e.g., variable bitrate (VBR), constant bitrate (CBR), constant rate factor (CRF), constant quantization parameter (constant QP), etc.), one pass vs. multi-pass encoding, and any other such parameters that define the how a piece of video information is to be encoded.

A bit rate is a rate at which the camera 110 records video. Bit rate is measured as a number of bits per second, e.g., megabits per second (Mbps). In some embodiments, the higher the bitrate the higher the quality of the encoded video stream.

A frame rate is a number of frames that appear every second, which is measured in frames per second (fps). In some embodiments, the higher the frame rate, the more frames per second are used to display the sequence of images, resulting in smoother motion. The trade-off for higher quality, however, is that higher frame rates require a larger amount of data, which uses more bandwidth.

A GOP size is a number of frames between two consecutive key frames. In some video encoding types, such as MPEG-4 and H.264, the video stream consists of I-frames (key frames), P-frames, and B-frames (collectively referred as “delta frames”). An I-frame or the key frame is a self-containing frame or complete video frames that do not need references to other frames. P-frame and B-frame uses reference to previous I- or P-frame, and will contain only information about the content that is different compared to previous frame. The GOP stands for the number of frames between two I-frames. By increasing the length of GOP, there will be less I-frames per a certain amount of time. Since key frames are much bigger than delta frames by size, longer gaps between key frames can optimize the bandwidth consumption and storage space consumption. In some embodiments, the lower the GOP size the higher the bit rate and higher the file size of the encoded video stream.

A resolution of the video feed is indicative of a number of pixels used for recording the video feed. In some embodiments, the higher the resolution the higher the quality of the encoded video stream, the greater the file size of the encoded video stream and greater the network bandwidth consumed in transmission of the encoded video stream. For example, a High-Definition (HD) or 720p resolution uses 1280×720 pixels, a full HD or 1080p resolution uses 1920×1080, and a 4K resolution uses 3840×2160 pixels.

An encoding type indicates a type of encoding used for encoding the video feed 135, such as H.264, H.265, HEVC, all of which differ in the video compression formats used for encoding the video and can result in consuming different amounts of computing resources for producing an encoded video stream of a specified quality, and/or produce different qualities of encoded video streams.

A rate control parameter indicates how bitrate will be managed to ensure successful transmission given non-ideal network conditions. For example, CRF (the default rate control mode for H.264 and H.265 encoders) aims to achieve a constant perceived quality level (based on an input parameter value). To achieve such constant quality, the CRF mode may vary compression of frames differently, thereby varying the quantization parameter as necessary to maintain a certain level of perceived quality. Similarly, Constant QP aims to maintain a constant quantization parameter which defines how much information to discard from a given block of pixels in a frame and can result in widely varying bitrates over a sequence of frames.

The encoder parameters applied by a camera 110 to encode a video stream impact the requirements (e.g., transmission power, bandwidth, throughput, latency, packet loss rate, etc.) for successful transmission of quality video to a user device. Accordingly, in some embodiments, data regarding applied encoder parameters can be important to selecting an appropriate channel for transmission of an encoded video stream.

In some embodiments, encoder parameters are independently set by each of the one or more cameras 110 of a camera system. Accordingly, in some embodiments, step 502 includes acquiring, for example by base station 105 and/or other wireless APs 120, data regarding applied encoder parameters from each of the one or more cameras 110. Such data may be requested and retrieve from the cameras 110 continuously, continually (e.g., periodically according to a set schedule), or intermittently in response to certain events. For example, in some embodiments, a camera 110 may announce its encoder parameters to base station 105 and/or other wireless APs 120 each time they wake from sleep and initiate transmission of a video stream.

Alternatively, or in addition, encoder parameters may be set by entities external to the camera 110. For example, in some embodiments the base station 105 (or other APs 120) may monitor conditions in the network and set encoder parameters for each of the one or more cameras in the network. Further, encoder parameters may be adjusted (periodically or on an event-driven basis) to respond to changes in network conditions. In other words, in some embodiments, an encoder selection process and video-based channel selection process may form a feedback loop to optimize transmission of quality video over the network.

In some embodiments, characteristics of a scene captured by a camera 110 may impact characteristics of an encoded video stream that results from the capture. For example, scene characteristics may impact how encoder parameters are applied to achieve quality video. This is based primarily on how the human eye perceives objects in the physical environment. For example, the human eye generally perceives more detail in still objects than in similar objects that are in motion. Similarly, the human eye can perceive more detail in objects that are relative close than in similar objects that are relatively far. Based on such facts, assumptions can be made regarding a level of detail necessary when encoding certain scene types which in turn impacts requirements to effectively transmit the encoded video stream over a wireless network.

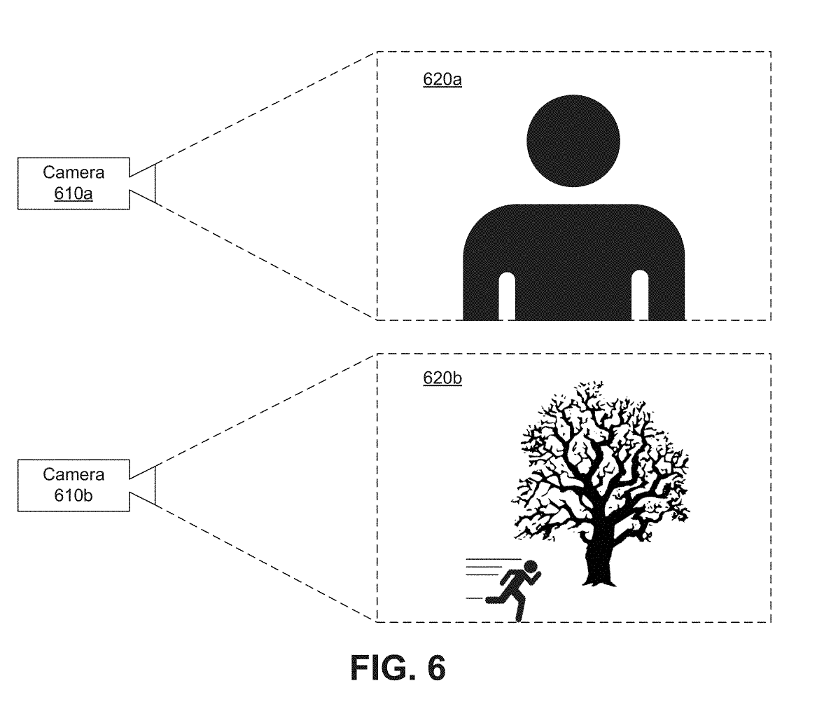

Consider, for example, the diagram depicted in FIG. 6 that shows a first camera 610a capturing a first scene 620a and a second camera 610b capturing a second scene 620b. As depicted, the two captured scenes may vary in one or more characteristics. Scene 620a includes a close-up of a human subject, while scene 620b includes a wider field of view with a human subject in motion. Accordingly, the human eye may require a higher level of detail in captured video of scene 620a than in the captured video of 620b. Such an assumption can be used to inform transmission requirements for video streams of the different scene types.

In an illustrative example, the two cameras shown in FIG. 6 may be part of a network-connected residential video surveillance camera system with the first camera 610a installed at front door entrance to the residence and camera 610b installed in a backyard. Although the scene captured at any particular camera may change continually over time, certain patterns may emerge based on the characteristics of the deployment of the cameras. For example, camera 610a installed at the front door entrance to the residence may tend to capture close-up shots of people coming to the door of the residence while camera 610b installed in the backyard may tend to capture distant still objects (e.g., trees) along with distant objects in motion (e.g., a person running, etc.).

In a video surveillance scenario, details may be particularly important to a user viewing video captured by the first camera 610a because the camera is deployed to capture close-ups of people at the front door entrance. For example, camera 610a may capture video of a face of an intruder. Accordingly, an encoder may be selected to encode video captured by camera 610a to achieve higher levels of detail possibly at the expense of other criteria such as file size, latency, etc. In this particular scenario an H.264 encoder using constant QP may be a good option for cameras in a video surveillance system that are deployed at a front entrance or that otherwise tend to capture close-up video of people (particularly faces). Conversely, an encoder that applies higher compression (at the expense of detail) can be selected for processing video captured by camera 610b camera 610b deployed in a backyard of the residence.

In some embodiments, a user end user or installer) may specify the type of scene a camera is intended to capture when installing the camera, for example, by entering inputs via a graphical user interface at a user device. In the case of camera 610a, a user may input information to the system indicating that the camera 610a is installed at the front door. Such information may be used as an input indicative of deployment characteristics of the camera system in the encoder selection process. The user may also update entered information by providing new inputs via a similar interface during operation of the camera system. Accordingly, in some embodiments, step 502 may include receiving such user inputs as data indicative of characteristics of a video stream to be transmitted over the network.

In some embodiments, a computing system may infer information indicative of a scene captured by a particular camera 110 based on other available information, such as a camera type or a location of the installed camera. For example, an indication of a location of a camera 110 (e.g., relative to base station 105) may be used to infer that the camera is located at a front door of a house and that the camera is therefore likely to capture close up video of the faces of people. Based on this inference, a computing system may estimate a level of quality needed for video form the camera and thereby estimate certain requirements for the wireless link used to transmit the video. Accordingly, in some embodiments, step 502 may include determining a location of a camera 100 (e.g., using GPS or other localization techniques such as time of arrival (TOA), received signal strength (RSS), time difference of arrival (TDOA), etc.), inferring a characteristic of a scene captured by the camera 110 based on the location, and incorporating this information as data indicative of a characteristic of the video stream. Similar inferences may be made based on other information such as the type or capabilities of the camera (e.g., color vs. black and white, high definition vs standard definition, etc.).

In some embodiments, computer vision may be applied to analyze video captured by a camera 110 to determine characteristics of the scene captured by the camera 110. For example, a computing system applying computer vision techniques may process video captured by camera 110 over time to determine that camera 110 tends to capture close-up video of human subjects. Based on this information, the computing system may determine that higher detail is necessary when encoding video and thereby inform selection of an appropriate channel for transmission of an encoded video stream. Accordingly, in some embodiments, step 502 may include, processing video captured by a camera 110 using computer vision techniques, detecting one or more physical objects in the captured video based on the processing, determining scene characteristics based on the detected objects, and inputting the determines scene characteristics as data indictive of a video stream to be transmitted over the wireless network. In some embodiments, the process of detecting physical objects in the captured video may include identifying, recognizing, and/or classifying the detected physical objects through observation, for example, using machine learning techniques such as deep learning and neural networks.

Returning to FIG. 5, the example process 500 continues at step 504 with selecting a channel for communication between a wireless camera 110 and wireless AP 120 based on the data received at step 502. Specifically, this step may include selecting a channel that can effectively accommodate transmission of a video stream from the camera 110 given known or estimated network conditions and known or estimated transmission requirements of the video stream. Note that in the context of this disclosure, selecting a “channel” may also include selecting a frequency band within which a channel resides. In other words, selecting a channel may include, for example, selecting between the 2.4 GHz frequency band and the 5 GHz frequency band in a multi-band wireless network.

In some embodiments, the process of selecting a channel at step 504 may include selecting a channel that satisfies a threshold criterion based on the data received at step 502. For example, based on data received at step 502, a computing system may determine a threshold level of throughput needed to accommodate a video stream from a given camera 110. This threshold level of throughput may be based, for example, on the encoder parameters applied by the camera 110 to generate the video stream taking into account some overhead margin. Based on this threshold level of throughput, the computing system may select a channel that satisfies the threshold level of throughput, for example, based on the receive data indicative of network conditions. Threshold criteria based on other performance metrics such as interference, utilization, bandwidth, noise, packet loss, latency, signal range, signal strength, etc. can also similarly be applied.

The actual analysis applied to determine whether a particular channel satisfies a given threshold criterion may vary on the criterion applied, system implementation specifics, and/or user preferences. For example, in the case of throughput, a computing system may measure or calculate any of maximum theoretical throughput, asymptotic throughput, peak measured throughput, maximum sustained throughput, etc. to determine whether a threshold throughput criterion is satisfied.

In some embodiments, the process of selecting a channel at step 504 may include selecting the best channel that satisfies one or more threshold criteria. For example, a computing system at a wireless AP 120 may scan one or more of a plurality of available channels, identify one or more of the scanned channels that satisfies one or more threshold criteria, and select the best (e.g., lowest latency, lowest noise, lowest utilization, etc.) from the identified one or more channels that satisfy the one or more threshold criteria. Alternatively, the computing system may simply select the first scanned channel that satisfies the one or more selection criteria.

In some embodiments, the channel selection process may operate as optimization process to select a channel from a set of available channels that most closely satisfies one or more selection criteria given one or more constraints based on the received data. For example, in contrast to selecting channels based on whether specified thresholds are met for one or more performance metrics, a computing system may analyze how certain combinations of network conditions and encoding schemes impact a quality level of a resulting video stream and apply this analysis to select an optimal channel that will result in the highest quality video delivered to a user device. In some embodiments, machine learning can be implemented to optimize channel selection. Machine learning techniques that can be implemented may include one or more of supervised and unsupervised modeling techniques, such as, linear regression, logistic regression, Naïve Bayes, decision trees, random forests, support vector machines, kmeans, hierarchical clustering, association mining, time series modeling techniques, Markovian approaches, text mining models, stochastic modeling techniques, neural networks, etc.

Once a channel is selected at step 504 based on data received at step 502, the example process 500 continues at step 506 with establishing a wireless link on the selected channel (if a link is not already established) or moving an existing wireless link from a current channel to the selected channel. Specifically, step 506 may include establishing a wireless link between a wireless camera 110 and a wireless AP 120 (or base station 105) on the selected channel or moving an existing wireless link between the wireless camera 110 and wireless AP 120 (or base station 105) to the selected channel.

### Switching Channels

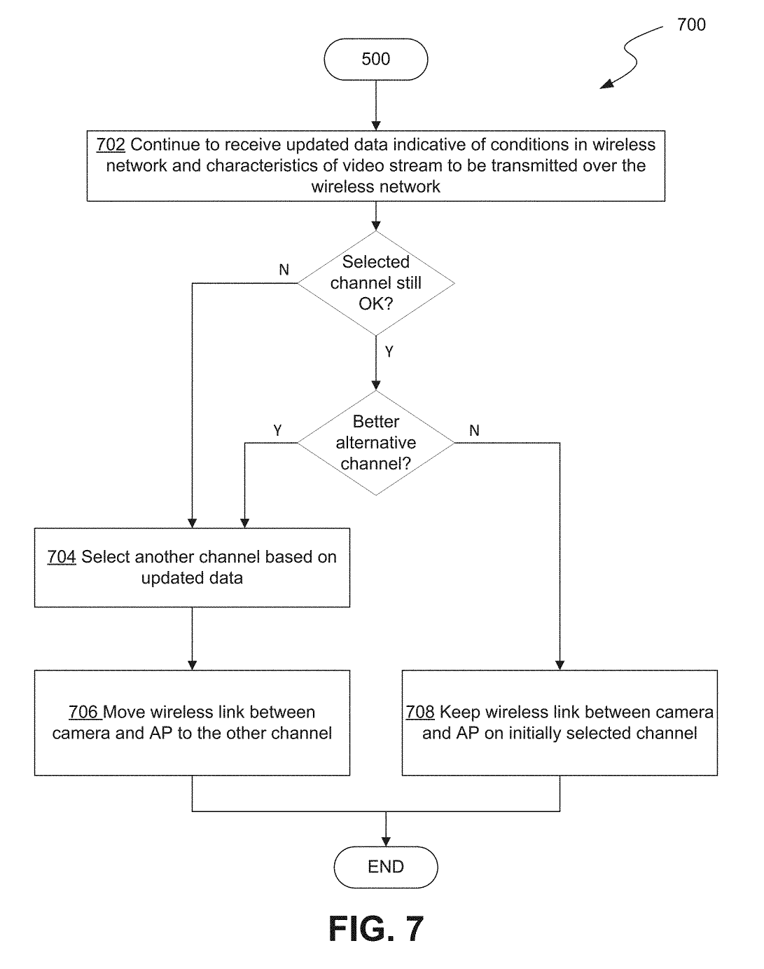

FIG. 7 shows a flow chart of an example process 700 for switching channels based on the described technique for video-based channel selection. As with the example process 500, the example process 700 is described as being performed by a computing system (e.g., such as computing system 1500 described with respect to FIG. 15). For example, the process depicted in FIG. 7 may be represented in instructions stored in memory that are then executed by a processor. A person having ordinary skill in the art will understand that the components of such a computing system may be distributed across one or more entities of the example environment 100 described with respect to FIG. 1. The process 700 described with respect to FIG. 7 is an example provided for illustrative purposes and is not to be construed as limiting. Other processes may include more or fewer steps than depicted while remaining within the scope of the present disclosure. Further, the steps depicted in example process 700 may be performed in a different order than is shown.

The example process 700 continues from process 500 and assumes that a wireless link is already established on a selected channel between a wireless camera 110 and a wireless AP 120 (or base station 105). The selected channel in this instance may have been selected using the described technique for video-based channel selection or alternatively may have been selected using any other selection technique (e.g., simply selecting a default channel).

The example process 700 begins at step 702 with continuing to receive data indicative of conditions in the wireless network and of a video stream to be transmitted over the wireless network. Based on the received data, the computing system determines whether the selected channel can still accommodate the video stream. For example, based on the received data the computing system may determine that the selected channel has failed, or that interference has increased based a threshold level, or that utilization has increased, or that the throughput requirements of the video stream have increased. For any number of reasons, a previously selected channel may no longer be able to accommodate a video stream from the wireless camera 110.

If the previously selected channel is no longer able to accommodate transmission of the video stream, the process proceeds to step 704 to select another channel based on the updated data received at step 720. Channel selection at step 704 may be similar to channel selection described with respect to step 504 of process 500. The example process then continues at step 706 with moving the wireless (e.g., between the wireless camera 110 and the wireless AP 120) to the selected other channel.

If, however, the previously selected channel is still able to accommodate the video stream, a computing system may determine if another channel is available that is better than the currently selected channel. For example, the process may include scanning one or more of the available channels and identifying one or more channels that would result in an improvement in the transmission of the video stream. A channel may be determined to be better than the selected channel if, for example, it has lower latency, higher estimated throughput, longer range, lower interference, lower noise, lower utilization, etc.

If a better channel is available, process 700 may continue with selecting another channel at step 704 and moving the wireless link to the selected other channel at step 706. When traffic is moved from one channel to another channel, there is a time cost associated with the channel change. On a recipient's side, many packets may already be buffered, so for example, if the band is changed from the 2.4 GHz band to the 5 GHz band, then the buffer may be flushed, and previously transmitted and buffered data would need to be re-transmitted. Thus, if the processing system determines that a better channel is available, it may first determine that the is a minimum margin of improvement before moving the wireless link from one channel or band to another.

If a better channel is not available, processes 700 continues at step 708 with maintaining communications between the wireless camera 110 and the wireless AP 120 (or base station 105) on the previously selected channel.

In some embodiments, the example process 700 for switching channels may be performed continuously during operation of the network-connected camera system. In other words, a computing system may continuously receive updated data indicative of conditions in the wireless network and of a video stream to be transmitted over the wireless network and may continuously re-evaluate, based on the updated data, whether a current channel is still able to accommodate the video stream and/or if a better channel is available. Further, the processing system may be configured to respond in real time or near real time as-necessary to move the wireless link between a camera 110 and AP 120 (or base station 105) to a different channel to optimize performance.

As previously mentioned, there is a time cost associated with switching channels. Accordingly, in some embodiments, the process depicted in FIG. 7 may instead be performed periodically at regular or irregular intervals. For example, a computing system may be configured to receive updated data over the course of a day and once a day process the received data to either keep a wireless link on a currently selected channel or move the wireless link to another channel. The switching of channel may be strategically scheduled to occur during a regular downtime to avoid service interruption.

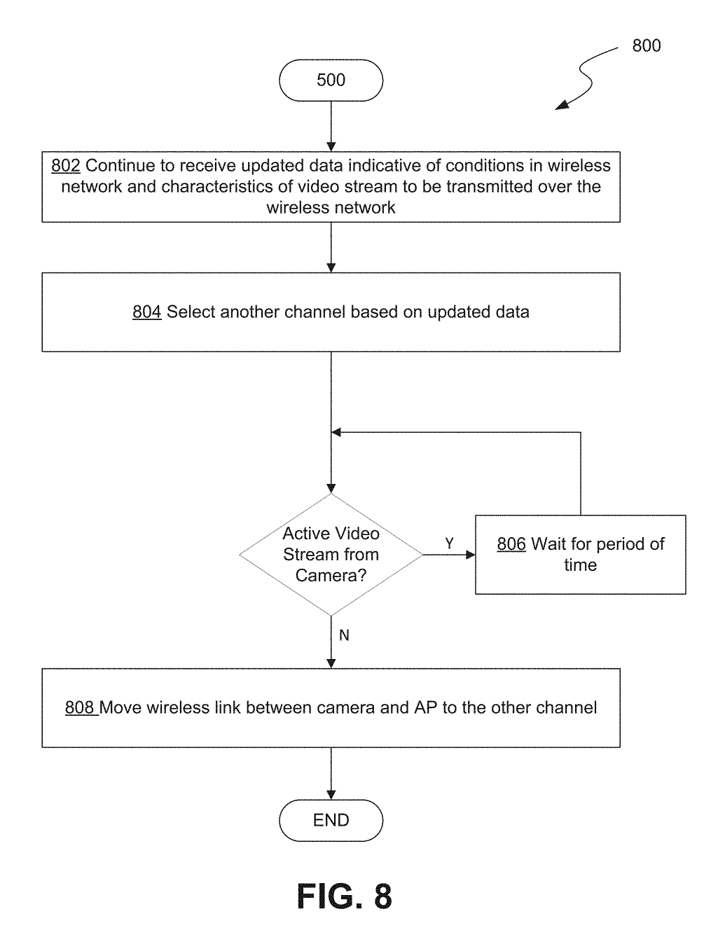

In some embodiments, the system may be configured to switch channels only when no active video stream is being transmitted to avoid interrupting the video stream. FIG. 8 shows a flow chart of an example process 800 for switching channels that avoids switching during an active video stream. As in example process 700, example process 800 continues from process 500 and begins at step 802 with continuing to receive data indicative of conditions in the wireless network and of a video stream to be transmitted over the wireless network.

At step 804, a computing system may select an alternative channel based on the updated received data, for example, in response to determining that a previously selected channel is no longer able to accommodate the video stream or that a better channel is available (e.g., as described with respect to process 700).

After selecting another channel, at step 806 the computing system first determines if there is an active video stream form the camera 110 before moving to the newly selected channel at step 808. If there is no active video stream, the computing system moves the wireless link between the camera 110 and the wireless AP 120 (or base station 105) to the channel selected at step 804. If there is an active video stream the computing system may wait at step 806 for a period of time (e.g., 60 seconds) before again determining if the video stream is still active. Once the video stream is no longer active, the computing system may move the wireless link to the newly selected channel.

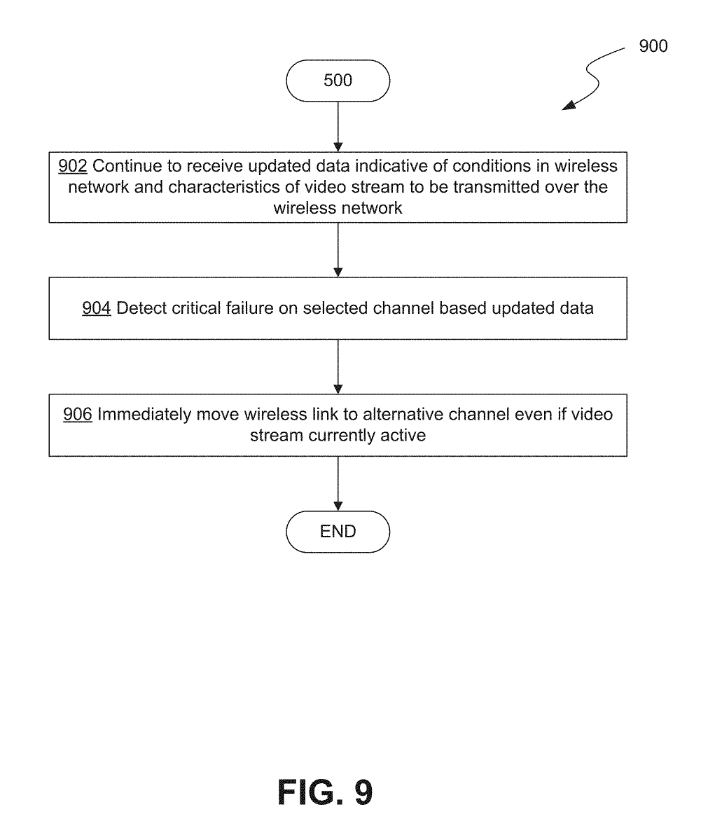

If the failure on a current channel is critical (e.g., the channel has failed or is very poor) the cost in loss of data or poor performance may outweigh the time cost of switching to another channel. Accordingly, in some embodiments, the system may be configured to immediately select a new channel and move communications to the new channel in response to detecting a critical failure on a current channel. FIG. 9 shows a flow chart of an example process 900 for immediately switching channels in response to detecting a critical failure. As in example process 700, example process 900 continues from process 500 and begins at step 902 with continuing to receive data indicative of conditions in the wireless network and of a video stream to be transmitted over the wireless network. The process 900 continues at step 904 with detecting a critical failure on a current channel based on the updated data. The process 900 continues at step 906 with immediately moving a wireless link between a wireless camera 110 and wireless AP 120 (or base station 105) to a selected alternative channel in response to the detected failure even if the wireless camera 110 is current transmitting a video stream over the wireless link.

### Channel Switch Announcement

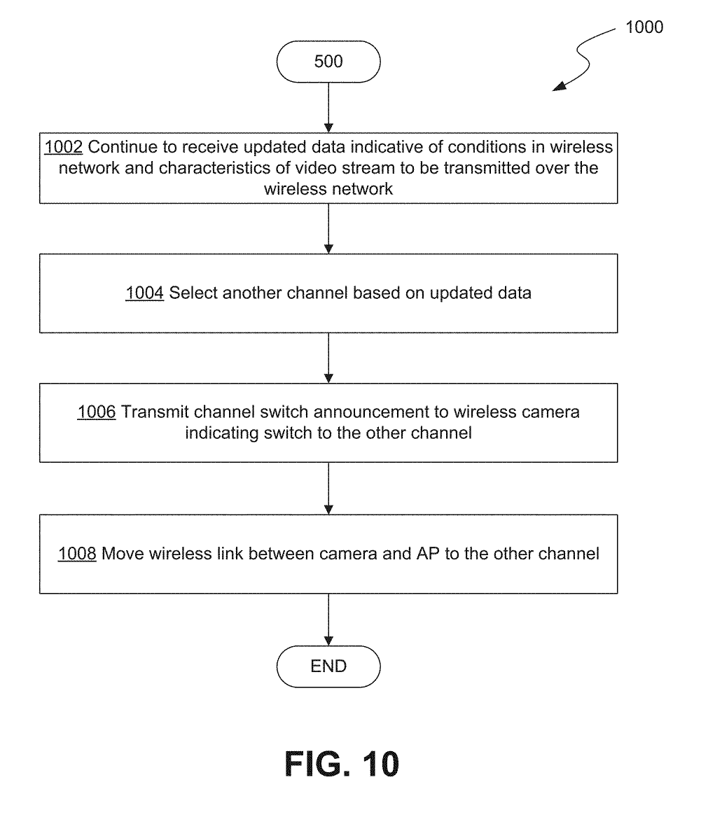

In some embodiments, channel switch announcement can be utilized when moving communications from one channel to another or one band to another. Channel switch announcement in this context generally refers to any sort of message or signal transmitted to a device operating in the multi-band wireless network informing the device that communications on a current channel are being switched to another channel or band. FIG. 10 shows a flow chart of an example process 1000 for channel switching with channel switch announcement. Example process 1000 continues from process 500 and begins at step 1002 with continuing to receive data indicative of conditions in the wireless network and of a video stream to be transmitted over the wireless network.

At step 1004, a computing system selects an alternative channel based on the updated received data, for example, in response to determining that a previously selected channel is no longer able to accommodate the video stream or that a better channel is available (e.g., as described with respect to process 700).

After selecting another channel, at step 1006 the computing system first transmits a channel switch announcement indicating a switch to the channel selected at step 1004 before moving a wireless link form a previously selected channel to the channel selected at step 1004. For example, a wireless AP 120 may transmit a channel switch announcement to a wireless camera indicating that a current wireless link between the wireless camera 110 and the wireless AP 120 will be moved from a current channel to a new channel or new band.

The channel switch announcement transmitted at step 1006 may comprise a signal, message, beacon, notification, or any other format of information configured to be received and interpreted by a client such as a wireless camera 110. The IEEE 802.11 standard defines a channel switch noncement element that can be utilized in Wi-Fi based wireless networks; however, a person having ordinary skill will understand that other notification techniques may similarly be employed.

Use of channel switch announcement may be particularly beneficial in a network-connected camera system that include motion activate wireless cameras. For example, in some embodiments, wireless cameras 110 are battery powered and are configured to generally operate in a low power sleep state to conserve energy. Such cameras may include or be coupled to motion sensors configured to detect motion in the physical environment in the vicinity of a camera 110. Such motion sensors may detect motion using any suitable technology such as passive infrared detection, reflective infrared detection, microwave detection, ultrasonic signals detection, vibration detection, computer vision processing, etc. In response to detecting motion, the camera 110 may wake from its low power sleep state and begin capturing video and transmitting a video stream based on the capturing.

In such a system, the wireless camera 110 may be asleep when a computing system (e.g., at a wireless AP 120) decides to select a new channel and move communications to the new channel. If the wireless camera 110 is not informed of the switch it may have to establish a new wireless link with the wireless AP 120 before initiating transmission of the video stream. To avoid needing to establish a new link, the wireless camera 110 may listen for channel switch announcements while in a seep state, for example, by periodically waking (e.g., once per second) to receive signals (e.g., beacons) from the wireless AP 120 that may include channel switch announcements. By receiving channel switch announcements, the wireless camera 110 knows which channel the wireless AP 120 is set to when it wakes from a low power sleep state to transmit a video stream, thereby avoiding having to reestablish a link with the wireless AP 120.

In some embodiments, the channel switch announcement transmitted at step 1006 may include timing information indicating when the wireless link will move from one channel or band to another. For example, a wireless AP 120 may transmit a channel switch announcement to a wireless camera 110 indicating a time when the when the wireless AP 120 will switch from a current channel or band to a new channel or band. By including timing information, the wireless camera 110 will know whether to continue communicating on a current channel or switch to a new channel indicated in the channel switch announcement.

### Access Restrictions in the 5 GHz Frequency Band

Depending on implementation specifics of a network-connected camera system selection of a channel in the 5 GHz frequency band may be generally preferable over a channel in the 2.4 GHz frequency band. FIG. 11 shows a diagram of channel allocation in the 5 GHz frequency band in various countries. The 5 GHz band includes many more allowable channels than are included in the 2.4 GHz band including channels at varying bandwidths (e.g., ranging from 20 MHz to 160 MHz available for Wi-Fi). Further, the 2.4 GHz frequency band has a greater effective range than the 5 GHz frequency band which is beneficial in some cases, but also leads to more interference from distance signal emitters. Also, particularly in a home network environment, the 2.4 GHz frequency band may experience more interface due to use by many other household devices such as cordless phones, Bluetooth devices, Zigbee devices, microwave ovens, etc.

As shown in FIG. 11, regulations in the United States and other countries allow access to Wi-Fi without restriction in certain portions of the 5 GHz band (e.g., ˜5150-5250 MHz and 5735-5835 MHz), restrict access to Wi-Fi completely in certain portions of the 5 GHz band (e.g., ˜5350-5470 MHz and 5835-5925 MHz), and allow Wi-Fi with dynamic frequency selection (DFS) in other portions of they GHz band (e.g., ˜5250-5330 MHz and 5490-5730 MHz). Dynamic frequency selection describes a mechanism by which unlicensed devices are allowed to use portions of the 5 GHz frequency band that are generally allocated for use by radar systems without interfering with the operation of the radar systems. Generally, operation on a DFS channel requires that a device monitor for the presence of radar transmissions on the channel and vacate the channel in response to detecting such transmission.

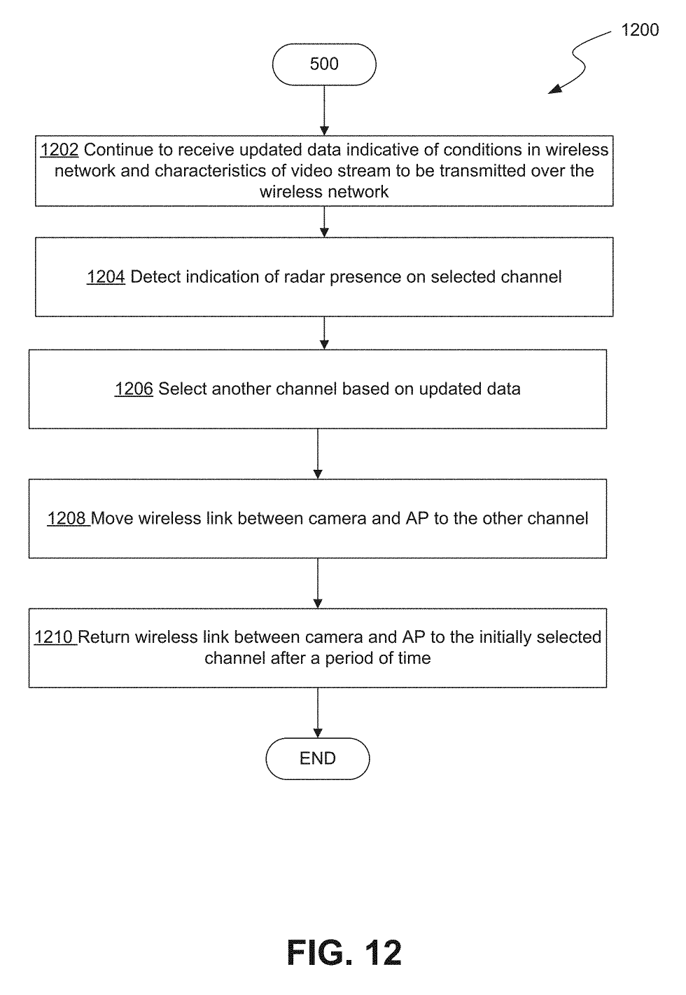

In some embodiments, selecting DFS channels in the 5 GHz band may be preferable as long as the networking devices (e.g., wireless AP 120) are configured for DFS. This preference is due to the fact that fewer home devices utilize DFS channels so they are generally less prone to interference. However, as indicated above, use of a DFS channel will require that a new channel be selected when the presence of radar is detected. FIG. 12 shows a flow chart of an example process 1200 for operating on a DFS channel. Example process 1200 continues from process 500 and begins at step 1202 with continuing to receive data indicative of conditions in the wireless network and of a video stream to be transmitted over the wireless network.

At step 1204, a computing system detects an indication of radar presence on the currently selected channel. For example, a wireless AP 120 configured for DFS may continually perform off-channel scanning to detect the presence of radar transmissions.

To comply with DFS requirements, in response to detecting the presence of radar, the processing system at step 1206 selects another channel based on updated data (e.g., using the previously described channel selection techniques) and at step 1208 moves the wireless link to the newly selected other channel to avoid interfering with the radar.

If a wireless AP 120 vacates a DFS channel due the detected presence of radar, the wireless AP 120 must remain off of the channel for a non-occupancy period mandated by regulation (generally 30 minutes). Accordingly, in some embodiments, process 1200 may include remaining off of the previously selected DFS channel for a period of time (e.g., 30 minutes) until the channel is cleared and then at step 1210 returning the wireless link back to the previously selected DFS channel.

In some embodiments, the computing system may continually pre-clear one or more alternative DFS channels so that at steps 1206-1208 it selects and moves communication to the pre-cleared alternative DFS channel. If another DFS channel has not been cleared, the processing system can instead select and move communications to an unrestricted channel in the 5 GHz band or a channel in the 2.4 GHz band.

### Strong Interference Close to Access Point

In some situations, a wireless AP 120 may experience strong interference from signals emitted in close proximity, for example, by another networking device such as another wireless AP or a cable router, etc. In such situations the interference may be so severe that it saturates the receiver at the wireless AP and reduces the benefits of selecting another channel for communication. If this situation is encountered, and the interfering device is a Wi-Fi device, it may be better to instead select the same channel as the interfering device, thereby allowing each to decode the other's signals and time share according to 802.11. By doing so the interference will not be destructive to both, although each will have less available utilization of the selected channel.

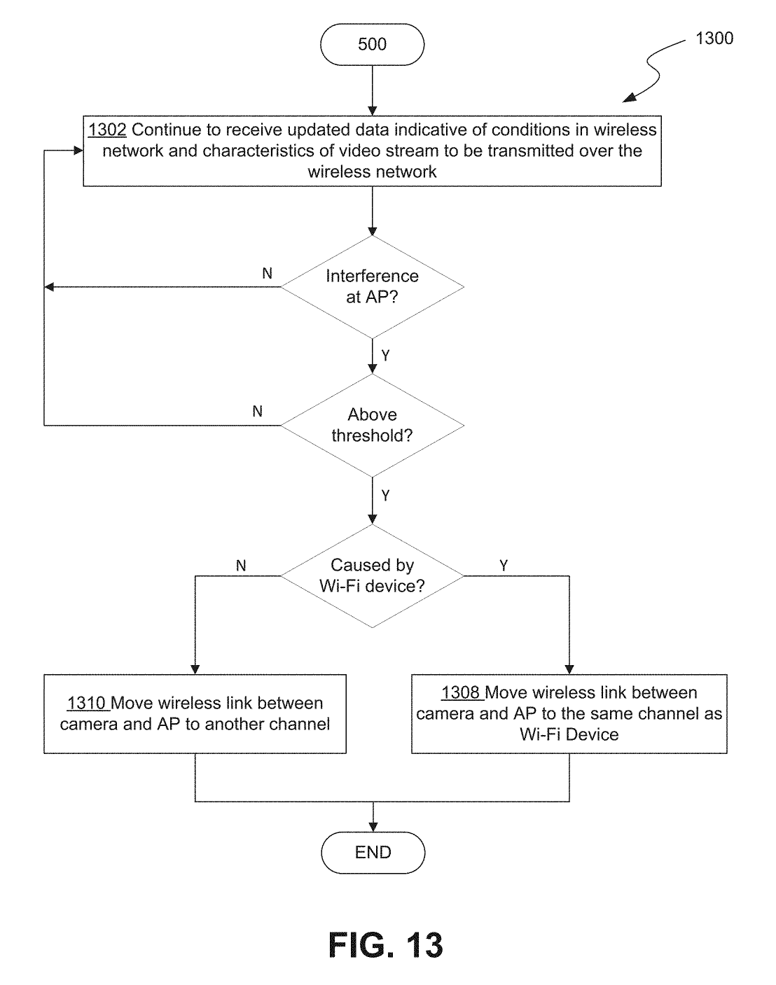

FIG. 13 shows a flow chart of an example process 1300 for responding to strong interference that is close to a wireless AP 120. Example process 1300 continues from process 500 and begins at step 1302 with continuing to receive data indicative of conditions in the wireless network and of a video stream to be transmitted over the wireless network.

If, based on the data received at step 1302, the system detects interference, for example, above a certain threshold, the system may select and move the wireless link to the same channel as the interfering device at step 1308 if the interfering device is a Wi-Fi device. Alternatively, if the interference is above the threshold and is not from a Wi-Fi device, process 1300 may instead continue at step 1310 with selecting and moving the wireless link to another channel or another band to try to avoid the interference. The interference threshold may be based, for example, on a detected received signal strength of the interfering device and/or a determined location of the interfering device relative to the wireless AP 120.

As previously mentioned, the ability of the wireless AP 120 to coexist on the same channel as the interfering Wi-Fi device may depend on the utilization of the channel. If the interfering Wi-Fi device is highly active leading to high percentage utilization of the channel, another channel or another band may instead be selected.

### Strong Interference Close to Wireless Camera

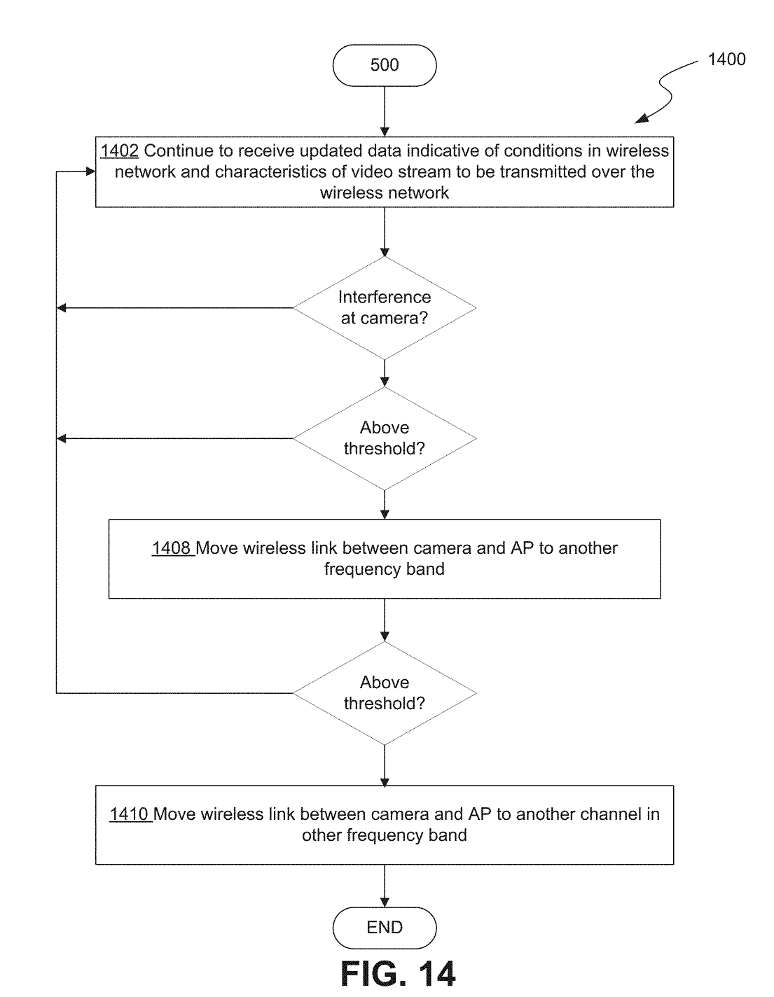

In some situations, a wireless camera 110 may experience strong interference from signals emitted in close proximity, for example, by other networking device such as other clients or other wireless APs. To alleviate the effects of such interference, the system may try switching to another band and if that does not help, may try switching to another channel in the other frequency band. FIG. 14 shows a flow chart of an example process 1400 for responding to strong interference that is close to a wireless camera 110. Example process 1400 continues from process 500 and begins at step 1402 with continuing to receive data indicative of conditions in the wireless network and of a video stream to be transmitted over the wireless network.

If, based on the data received at step 1402, the system detects interference, for example, above a certain threshold, the system may at step 1408 select and move the wireless link to another frequency band (e.g., form 2.4 GHz band to 5 GHz band or vice versa).

If, after moving to the wireless link to the other band, the system still detects interference above the threshold, the system may at step 1410 select and move the wireless link to another channel in the newly selected frequency band.

### Example Computing System

FIG. 15 is a block diagram of an example computer system 1500 as may be used to implement certain features of some of the embodiments. The computer system 1200 may be a server computer, a client computer, a personal computer (PC), a user device, a tablet PC, a laptop computer, a personal digital assistant (PDA), a cellular telephone, a telephone, a web appliance, a network router, switch or bridge, a console, a hand-held console, a (hand-held) gaming device, a music player, any portable, mobile, hand-held device, wearable device, or any other machine capable of executing a set of instructions (sequential or otherwise) that specify actions to be taken by that machine.

The computing system 1500 may include one or more processing units (e.g., central processing units (CPU) and/or graphical processing units (GPU) (collectively the “processor”) 1505, one or more memory units (collectively “memory”) 1510, one or more input/output devices 1525 (e.g. keyboard and pointing devices, touch devices, display devices, audio input/output devices, etc.) one or more storage devices 1520 (e.g. disk drives, solid state drives, etc.), and one or more network adapters 1530 (e.g., network interfaces) that can communicatively couple via an interconnect 1515. The interconnect 1515 is illustrated as an abstraction that represents any one or more separate physical buses, point to point connections, or both connected by appropriate bridges, adapters, or controllers. The interconnect 1515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Institute of Electrical and Electronics Engineers (IEEE) standard 1394 bus (also called Firewire), or any other suitable system for facilitating communication between the various components of the example computing system 1500.

The memory 1510 and storage device 1520 are computer-readable storage media that may store instructions that implement at least portions of the various embodiments. In addition, the data structures and message structures may be stored or transmitted via a data transmission medium (e.g., a signal on a communications link). Various communications links may be used such as the Internet, a local area network, a wide area network, or a point-to-point dial-up connection, etc. Thus, computer readable media can include computer-readable storage media, e.g. non-transitory media, and computer-readable transmission media.

The instructions stored in memory 1510 can be implemented as software and/or firmware to program the processor 1505 to carry out actions described above. In some embodiments, such software or firmware may be initially provided to the processor 1505 by downloading the software or firmware from a remote system through the computing system 1500, e g. via network adapter 1530.

The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

What is claimed is:

1. A method for video-based channel selection in network-connected camera system, the network-connected camera system including a wireless access point (AP) and a wireless camera, the wireless camera configured to capture video and transmit video streams based on the captured video to the wireless AP via a multi-band wireless network, the method comprising:
receiving, by a computing system, data indicative of conditions in the multi-band wireless network and characteristics of a video stream to be transmitted over the multi-band wireless network;
selecting, by the computing system, a first channel of a plurality of channels of the multi-band wireless network that can accommodate the video stream based on the received data; and
causing, by the computing system, a wireless link to be established between the wireless camera and the wireless AP on the first channel for transmission of the video stream.

2. The method of claim 1, further comprising:
determining, by the computing system that the selected first channel can no longer accommodate the video stream based on the received data;
selecting, by the computing system, in response to the determination, a second channel that can accommodate the video stream based on the received data; and
causing, by the computing system, the wireless link between the wireless camera and the wireless AP to move from the first channel to the second channel.

3. The method of claim 1, further comprising:
determining, by the computing system, that transmission of the video stream via a second channel will be improved relative to the first channel based on the received data;
selecting, by the computing system, in response to the determination, the second channel; and
causing, by the computing system, the wireless link between the wireless camera and the wireless AP to move from the first channel to the second channel.

4. The method of claim 3, wherein:
the first channel and second channel are in a first band of the multi-band wireless network; or
the first channel is in the first band and the second channel is in a second band of the multi-band wireless network.

5. The method of claim 4, wherein:
the wireless AP includes a first radio configured to operate in the first band and a second radio configured to operate in the second band; and
the wireless camera includes a switchable radio configured to switch between the first band and the second band.

6. The method of claim 4, wherein:
the first band is the 5 GHz band; and
the second band is the 2.4 GHz band.

7. The method of claim 1, further comprising:
selecting, by the computing system, a second channel of the plurality of channels of the multi-band wireless network based on the received data; and
waiting, by the computing system, for the wireless camera to complete transmission of the video steam before causing the wireless link between the wireless camera and the wireless AP to move from the first channel to the second channel.

8. The method of claim 1, wherein the wireless camera is motion activated and configured to operate in a low power sleep state when motion is not detected, the method further comprising:
selecting, by the computing system, a second channel of the plurality of channels of the multi-band wireless network based on the received data while the wireless camera is operating in the low power sleep state; and
causing, by the computing system, a channel switch announcement to be transmitted to the wireless camera indicative that the wireless link between the wireless camera and the wireless AP will move from the first channel to the second channel;
wherein receipt of the channel switch announcement enables the wireless camera to transmit over the second channel after waking from the low power sleep state without establishing a new wireless link with the wireless AP.

9. The method of claim 8, wherein the channel switch announcement includes timing information indicating when the wireless link between the wireless camera and the wireless AP will move from the first channel to the second channel.

10. The method of claim 1, wherein the selected first channel is a regulated dynamic frequency selection (DFS) channel, the method further comprising:
monitoring, by the computing system, for radar activity on the first channel;
detecting, by the computing system, an indication of radar activity on the first channel based on the monitoring;
selecting, by the computing system, a second channel of the plurality of channels of the multi-band wireless network in response to detecting the indication of radar activity on the first channel; and
causing, by the computing system, the wireless link between the wireless camera and the wireless AP to move from the first channel to the second channel.

11. The method of claim 10, further comprising:
causing, by the computing system, the wireless link between the wireless camera and the wireless AP to move back to the first channel from the second channel after a specified period of time.

12. The method of claim 1, wherein the data indicative of conditions in the multi-band wireless network is based on measurements performed by the wireless camera and/or the wireless AP.

13. The method of claim 12, wherein the wireless camera and wireless AP coordinate performing measurements so as not to interfere with transmission of the video stream.

14. The method of claim 1, further comprising:
causing, by the computing system, the wireless camera and/or wireless AP to perform the measurements.

15. The method of claim 1, further comprising:
periodically selecting, by the computing system, an alternative channel of the plurality of channels based on changes in the received data; and
causing, by the computing system, in response to the periodic selection, the wireless link between the wireless camera and the wireless AP to move to the alternative channel if there is no active video stream from the wireless camera.

16. The method of claim 1, further comprising:
detecting, by the computing system, interference above a threshold interference level caused by a device within a threshold proximity to the wireless AP based on the received data;
selecting, by the computing system, in response to the detection, a second channel; and
causing, by the computing system, the wireless link between the wireless camera and the wireless AP to move from the first channel to the second channel.

17. The method of claim 1, wherein data indicative of conditions in the multi-band wireless network includes a measure of any of interference, utilization, bandwidth, throughput, noise, packet loss, latency, signal range, or signal strength.

18. The method of claim 1, wherein data indicative of conditions in the multi-band wireless network includes an indication of available channels and available bands in the multi-band wireless network.

19. The method of claim 1, wherein the data indicative of the video stream to be transmitted over the multi-band wireless network includes any of:
an encoder parameter used to encode the video stream;
a format of the video stream;
a power requirement for transmission of the video stream; or
a characteristic of a scene captured in the video stream.

20. A system for video-based channel selection in a wireless network, the system comprising:
a processor; and
a memory coupled to the processor, the memory having instructions stored thereon, which when executed by the processor, cause the system to:
receive data indicative of conditions in the wireless network and characteristics of a video stream to be transmitted by a wireless camera over the wireless network;
select a first channel of a plurality of channels of the wireless network that can accommodate the video stream based on the received data; and
cause a wireless access point (AP) associated with the wireless network to establish a wireless link with the wireless camera on the first channel to receive a transmission of the video stream.

21. The system of claim 20, wherein the memory has further instructions stored thereon, which when executed by the processor, cause the system to further:
determine that the selected first channel can no longer accommodate the video stream based on the received data;
select, in response to the determination, a second channel that can accommodate the video stream based on the received data; and
cause the wireless AP to move the wireless link with the wireless camera from the first channel to the second channel.

22. The system of claim 20, wherein the memory has further instructions stored thereon, which when executed by the processor, cause the system to further:
determine that transmission of the video stream via a second channel will be improved relative to the first channel based on the received data;
select, in response to the determination, the second channel; and
cause the wireless AP to move the wireless link with the wireless camera from the first channel to the second channel.

23. The system of claim 20, wherein the memory has further instructions stored thereon, which when executed by the processor, cause the system to further:
select a second channel of the plurality of channels of the wireless network based on the received data; and
cause the wireless AP to wait for the wireless camera to complete transmission of the video steam before moving the wireless link with the wireless camera from the first channel to the second channel.

24. The system of claim 20, wherein the wireless camera is motion activated and configured to operate in a low power sleep state when motion is not detected and wherein the memory has further instructions stored thereon, which when executed by the processor, cause the system to further:
select a second channel of the plurality of channels of the wireless network based on the received data while the wireless camera is operating in the low power sleep state; and
cause the wireless AP to transmit a channel switch announcement to the wireless camera indicative that the wireless link will move from the first channel to the second channel;
wherein receipt of the channel switch announcement enables the wireless camera to transmit over the second channel after waking from the low power sleep state without establishing a new wireless link with the wireless AP.

25. The system of claim 20, wherein the selected first channel is a regulated dynamic frequency selection (DFS) channel and wherein the memory has further instructions stored thereon, which when executed by the processor, cause the system to further:
monitor for radar activity on the first channel;
detect an indication of radar activity on the first channel based on the monitoring;
select a second channel of the plurality of channels of the wireless network in response to detecting the indication of radar activity on the first channel;
cause the wireless AP to move the wireless link with the wireless camera from the first channel to the second channel; and
cause the wireless AP to move the wireless link with the wireless camera back to the first channel from the second channel after a specified period of time.

26. The system of claim 20, wherein the memory has further instructions stored thereon, when executed by the processor, cause the system to further:
periodically select an alternative channel of the plurality of channels based on changes in the received data; and
cause the wireless AP to move the wireless link with the wireless camera to the alternative channel in response to the periodic selection if there is no active video stream from the wireless camera.

27. A non-transitory computer-readable storage medium storing instructions for causing the computing system to:
receive data indicative of conditions in a wireless network and characteristics of a video stream to be transmitted by a wireless camera over the wireless network;
select a first channel of a plurality of channels of the wireless network that can accommodate the video stream based on the received data; and
cause a wireless access point (AP) associated with the wireless network to establish a wireless link with the wireless camera on the first channel to receive a transmission of the video stream.

28. The non-transitory computer-readable storage medium of claim 27 storing further instructions for causing the computing system to further:
determine that the selected first channel can no longer accommodate the video stream based on the received data;
select, in response to the determination, a second channel that can accommodate the video stream based on the received data; and
cause the wireless AP to move the wireless link with the wireless camera from the first channel to the second channel.

29. The non-transitory computer-readable storage medium of claim 27 storing further instructions for causing the computing system to further:
determine that transmission of the video stream via a second channel will be improved relative to the first channel based on the received data;
select, in response to the determination, the second channel; and
cause the wireless AP to move the wireless link with the wireless camera from the first channel to the second channel.

30. The non-transitory computer-readable storage medium of claim 27 storing further instructions for causing the computing system to further:
select a second channel of the plurality of channels of the wireless network based on the received data; and
cause the wireless AP to wait for the wireless camera to complete transmission of the video steam before moving the wireless link with the wireless camera from the first channel to the second channel.

31. The non-transitory computer-readable storage medium of claim 27 storing further instructions for causing a computing system to further:
select a second channel of the plurality of channels of the wireless network based on the received data while the wireless camera is operating in a low power sleep state;
wherein the wireless camera is motion activated and configured to operate in the low power sleep state when motion is not detected; and
cause the wireless AP to transmit a channel switch announcement to the wireless camera indicative that the wireless link will move from the first channel to the second channel;
wherein receipt of the channel switch announcement enables the wireless camera to transmit over the second channel after waking from the low power sleep state without establishing a new wireless link with the wireless AP.

32. The non-transitory computer-readable storage medium of claim 27 storing further instructions for causing a computing system to further:
monitor for radar activity on the first channel if the first channel is a regulated dynamic frequency selection (DFS) channel;
detect an indication of radar activity on the first channel based on the monitoring;
select a second channel of the plurality of channels of the wireless network in response to detecting the indication of radar activity on the first channel;
cause the wireless AP to move the wireless link with the wireless camera from the first channel to the second channel; and
cause the wireless AP to move the wireless link with the wireless camera back to the first channel from the second channel after a specified period of time.

33. The non-transitory computer-readable storage medium of claim 27 storing further instructions for causing a computing system to further:
periodically select an alternative channel of the plurality of channels based on changes in the received data; and
cause the wireless AP to move the wireless link with the wireless camera to the alternative channel in response to the periodic selection if there is no active video stream from the wireless camera.
